(19) United States
(12) Patent Application Publication
(10) Pub. No.: US 2012/0223919 A1
(43) Pub. Date: Sep. 6, 2012

(54) TOUCH PEN

(76) Inventors: Ming-Chuan LIN, Taichung City (TW); Wen-Hung Wang, Taichung City (TW); Chih-Chiang Lin, Taichung City (TW); Shyh-Jeng Chen, Taichung County (TW); Jer-Yann Huang, Taichung City (TW); Wen-Hsin Wang, Chang Hua City (TW)

(21) Appl. No.: 13/410,008

(22) Filed: Mar. 1, 2012

(30) Foreign Application Priority Data
Mar. 2, 2011 (TW) 100106804

(51) Int. Cl. G06F 3/033

(52) U.S. Cl. 345/179

(57) ABSTRACT

A touch pen includes a power supply circuit, a signal-receiving electrode, an inverted amplifying circuit and a signal-emitting electrode. The power supply circuit provides the touch pen with a working voltage, and the signal-receiving electrode receives at least one surface signal of a touch-sensing structure of a capacitive touch-sensitive device. The inverted amplifying circuit reversely amplifies the surface signal to generate a reversely amplified signal, and the signal-emitting electrode emits the reversely amplified signal to attenuate a detection signal of the capacitive touch-sensitive device in a position coinciding with a touch point of the touch pen.

### BACKGROUND OF THE INVENTION

a. Field of the Invention

The invention relates to a touch pen in general and more specifically to a touch pen for a capacitive touch-sensitive device.

b. Description of the Related Art

FIG. 1A and FIG. 1B show schematic diagrams illustrating a conventional operation of sensing touch points of a user's finger on a capacitive touch-sensitive device 100. Referring to FIG. 1A and FIG. 1B, each Y-axis electrode 102, for example, may emit a voltage pulse to detect induced charge on each X-axis electrode 104. Therefore, compared with a pulse signal transmitted to a non-touch position, finger capacitance is formed, as a result of a human body being grounded, in a touch position to weaken a pulse signal transmitted to an X-axis electrode 104 coinciding with the touch position. Accordingly, the X-axis electrodes 104 that are currently touched by fingers 106 are detected to figure out touch position coordinates of the fingers 106. Further, since the voltage pulse is successively applied to a group of Y-axis electrodes, the presence of two or more points of contact with the surface of the capacitive touch-sensitive device 100 at a time can still be accurately recognized.

Further, nowadays different designs of a touch pen used for a capacitive touch-sensitive device have been proposed. Among these designs, an outside diameter of a pen head is set as about 5 to 6 mm and fails to be further reduced because a too small pen head may result in insufficient coupling capacitance. However, a pen head with an outside diameter of about 5 to 6 mm is too large to perform accurate touch operations.

### BRIEF SUMMARY OF THE INVENTION

The invention provides a touch pen for a capacitive touch-sensitive device.

Other objects and advantages of the invention can be better understood from the technical characteristics disclosed by the invention. In order to achieve one of the above purposes, all the purposes, or other purposes, one embodiment of the invention provides a touch pen including a power supply circuit, a signal-receiving electrode, an inverted amplifying circuit and a signal-emitting electrode. The power supply circuit provides the touch pen with a working voltage, and the signal-receiving electrode receives at least one surface signal of a touch-sensing structure of a capacitive touch-sensitive device. The inverted amplifying circuit reversely amplifies the surface signal to generate a reversely amplified signal, and the signal-emitting electrode emits the reversely amplified signal to attenuate a detection signal of the capacitive touch-sensitive device in a position coinciding with a touch point of the touch pen.

According to the above embodiment, a pen head of the touch pen is allowed to be minimized to perform accurate touch operations on a capacitive touch-sensitive device. Besides, the capacitive touch-sensitive device does not need to be specifically designed to accurate sense touch positions of the touch pen, and the head electrode of the touch pen can be independently designed, where the compatibility between the head electrode and a driver IC of the capacitive touch-sensitive device does not need to be taken into consideration. This considerably reduces design complexity and fabrication costs.

In one embodiment, an amplifying power of the inverted amplifying circuit is 50-500.

In one embodiment, the touch pen further includes a shielding element interposed between the signal-receiving electrode and the signal-emitting electrode to avoid signal interference. The shielding element may be made of a copper foil. The signal-emitting electrode may include an antenna structure and an electrode wire, the shielding element may include a hollow cylindrical part and an annular part connected with one end of the hollow cylindrical part, and the electrode wire is disposed inside the hollow cylindrical part. An outside diameter of the hollow cylindrical part may be equal to or slightly larger than an outside diameter of the antenna structure. A first insulation member is interposed between the signal-receiving electrode and the shielding element, and a second insulation member is interposed between the signal-emitting electrode and the shielding element.

In one embodiment, each of the first insulation member and the second insulation member is in the shape of a cylinder. A length of the first insulation member is larger than a length of the signal-receiving electrode in an extending direction of the electrode wire.

In one embodiment, the signal-receiving electrode is made of a metal ring or conductive coils, and a conductive rubber surrounds the antenna structure. An outside diameter of the annular part may be substantially equal to an outside diameter of the conductive rubber.

In one embodiment, the touch-sensing structure comprises a plurality of first sensing series and a plurality of second sensing series, the first sensing series receive at least one scan signal, each sensing series driven by the scan signal emits power lines that are received by the signal-receiving electrode, and the second sensing series receive the detection signal.

According to another embodiment of the invention, a touch pen includes a power supply circuit, a head electrode and a multiplexer. The power supply circuit provides the touch pen with a working voltage, and the head electrode receives at least one surface signal of a touch-sensing structure of a capacitive touch-sensitive device. The surface signal is reversely amplified by an inverted amplifying unit to generate a reversely amplified signal, and the head electrode emits the reversely amplified signal to attenuate a detection signal of the capacitive touch-sensitive device in a position coinciding with a touch point of the touch pen. The multiplexer allows the head electrode to switch between a signal reception path and a signal emission path.

In one embodiment, the touch pen further includes a memory for temporarily storing the patterns of the reversely amplified signal.

In one embodiment, the inverted amplifying unit and the multiplexer are integrated into an application specific integrated circuit (ASIC).

According to the above embodiments, since the signal-receiving operation and the signal-emitting operation are both performed by a single head electrode, the problem of interference between signal reception and signal emission is eliminated and the pen head is allowed to be further minimized.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A and FIG. 1B show schematic diagrams illustrating a conventional operation of sensing touch points of a user's finger on a capacitive touch-sensitive device.

FIG. 2 shows a touch pen for a capacitive touch-sensitive device according to an embodiment of the invention.

FIG. 3 shows a block diagram illustrating operations of the touch pen shown in FIG. 2.

FIG. 4 shows a circuit diagram of an inverted amplifying circuit according to an embodiment of the invention.

FIG. 5 shows a schematic diagram of a signal-emitting electrode and a signal-receiving electrode according to an embodiment of the invention.

FIG. 6 and FIG. 7 show schematic diagrams of a touch pen for a capacitive touch-sensitive device according to another embodiment of the invention.

FIG. 8 shows a block diagram illustrating the operation of the touch pen.

FIG. 9 shows a schematic diagram illustrating an input device of a touch pen or fingers for a capacitive touch-sensitive device.

FIG. 10 shows a schematic diagram of a touch pen for a capacitive touch-sensitive device according to another embodiment of the invention.

FIG. 11 shows a schematic diagram of a touch pen for a capacitive touch-sensitive device according to another embodiment of the invention.

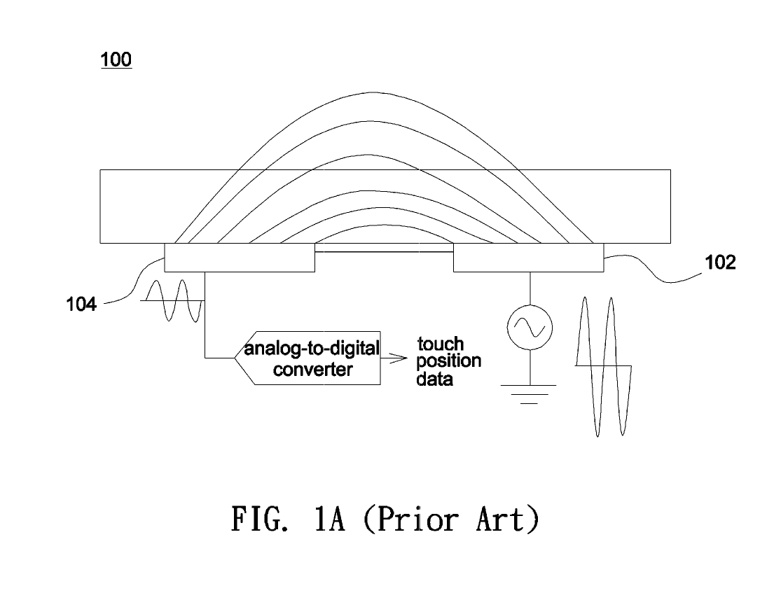

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

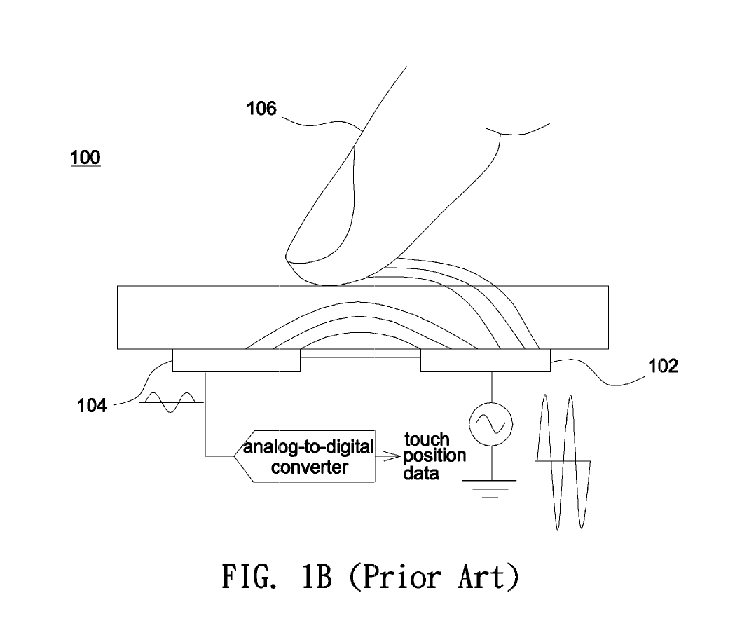

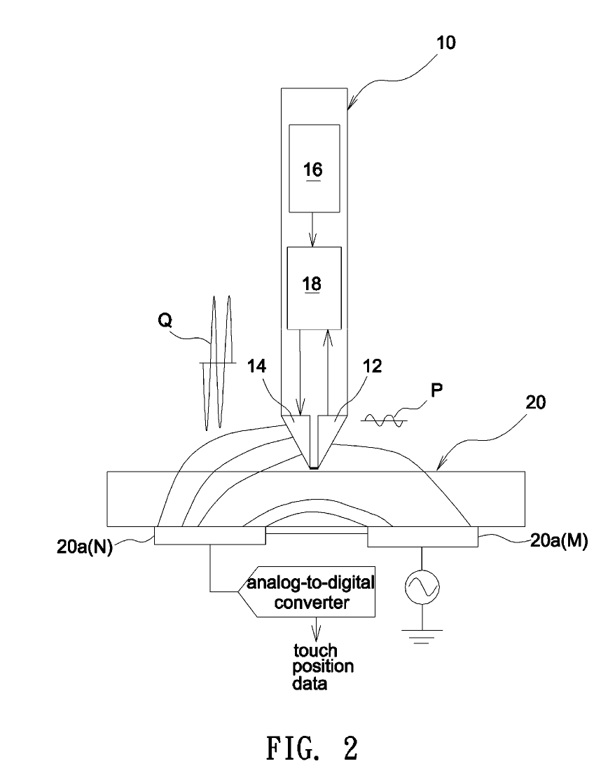

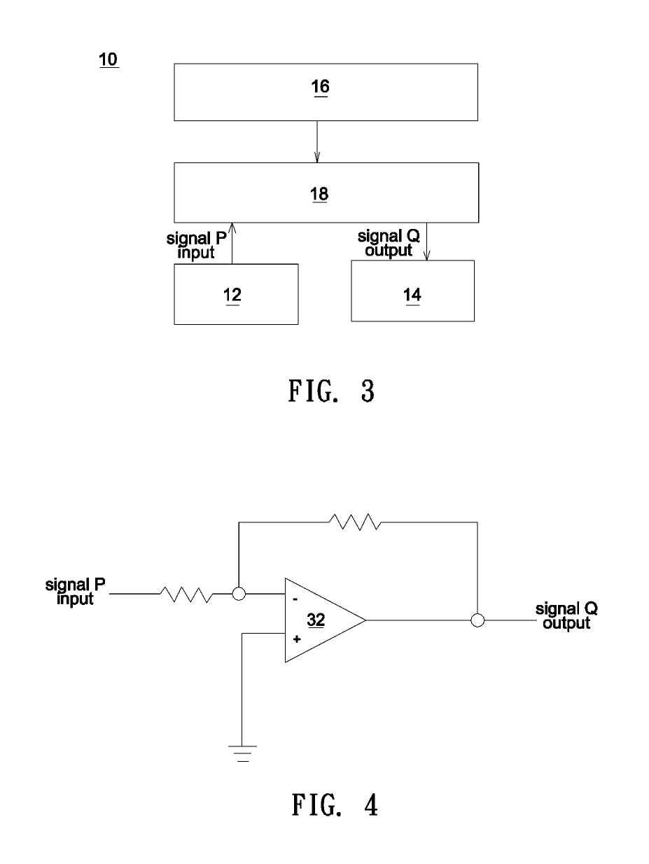

FIG. 2 shows a touch pen for a capacitive touch-sensitive device according to an embodiment of the invention. FIG. 3 shows a block diagram illustrating operations of the touch pen shown in FIG. 2. Please refer to both FIG. 2 and FIG. 3, a touch pen 10 includes a signal-receiving electrode 12, a signal-emitting electrode 14, a power supply circuit 16, and an inverted amplifying circuit 18. The power supply circuit 16 provides the touch pen 10 with a working voltage. The signal-receiving electrode 12 receives, such as by induction, at least one surface signal P of a touch-sensing structure 20a of a capacitive touch-sensitive device 20. The touch-sensing structure 20a may include multiple first sensing series M and multiple second sensing series N. In one embodiment, the first sensing series M receive at least one scan signal and are successively driven by the scan signal to scan the entire touch-sensing structure 20a. Each sensing series M driven by the scan signal emits power lines that are received by the signal-receiving electrode 12. The second sensing series N receive at least one detection signal to sense coupling capacitance formed as a result of a touch operation when the scan signal successively drives the first sensing series M. In one embodiment, the surface signal P is induced by the power lines between the touch-sensing structure 20a(M) and the signal-receiving electrode 12, and the detection signal is induced by the power lines between the touch-sensing structure 20a(N) and the signal-emitting electrode 14. The inverted amplifying circuit 18 reversely amplifies the surface signal P of the touch-sensing structure 20a to generate a reversely amplified signal Q, and the signal-emitting electrode 14 emits the reversely amplified signal Q. The reversely amplified signal Q attenuates a detection signal in a position coinciding with a touch point of the touch pen 10, and therefore a detection signal in the position coinciding with a touch point is weaken compared with other detection signals in non-touch positions to recognize current touch positions of the touch pen 10. FIG. 4 shows a circuit diagram of the inverted amplifying circuit 18 according to an embodiment of the invention. The structure of the inverted amplifying circuit 18 is not limited, as long as the effect of reversely amplifying surface signals P of the touch-sensing structure 20a is achieved. For example, an operational amplifier 32 that has linear gain control may function as an inverted amplifying circuit, where the output of the operational amplifier 32 is controlled by its input.

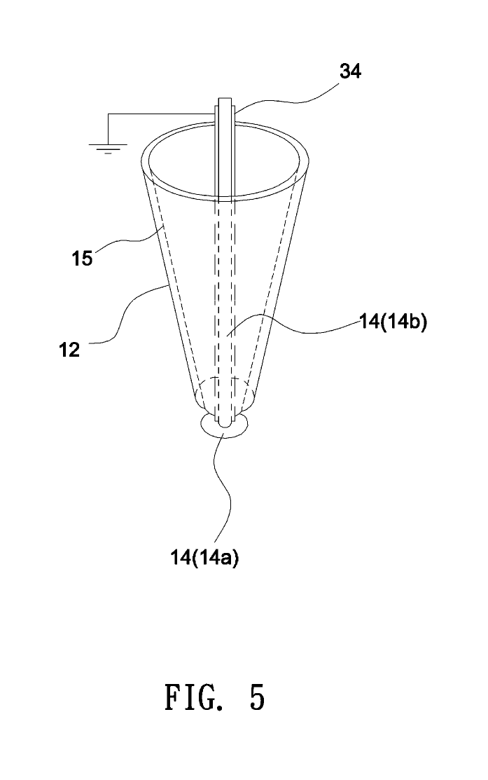

Referring to FIG. 5, in one embodiment, the signal-emitting electrode 14 may include an antenna structure 14a and an electrode wire 14b. A conductor 34 such as a copper foil may be used to shield the electrode wire 14b to avoid that the signal-receiving electrode 12 does not receive a surface signal P of the touch-sensing structure 20a but instead mistakenly receives a reversely amplified signal Q emitted by the signal-emitting electrode 14. That is, the conductor 34 may provide shielding effects to avoid single interference and ensure a normal operation of the touch pen 10. Besides, one end of the antenna structure 14a is connected to an output end for outputting a reversely amplified signal Q, as shown in FIG. 4. Further, an insulation layer 15 is interposed between the signal-receiving electrode 12 and the signal-emitting electrode 14 to avoid direct contact between the signal-receiving electrode 12 and the signal-emitting electrode 14.

According to the above embodiments, only a tiny amount of power lines is needed to generate a surface signal P, and the surface signal P is reversely amplified to attenuate a detection signal of the capacitive touch-sensitive device 20 to detect touch positions. Therefore, a pen head of the touch pen 10 is allowed to be minimized to perform accurate touch operations on the capacitive touch-sensitive device 20. Besides, the capacitive touch-sensitive device 20 does not need to be specifically designed to accurate sense touch positions of the touch pen 10, and the head electrode of the touch pen 10 can be independently designed, where the compatibility between the head electrode and a driver IC of the capacitive touch-sensitive device 20 does not need to be taken into consideration. This considerably reduces design complexity and fabrication costs.

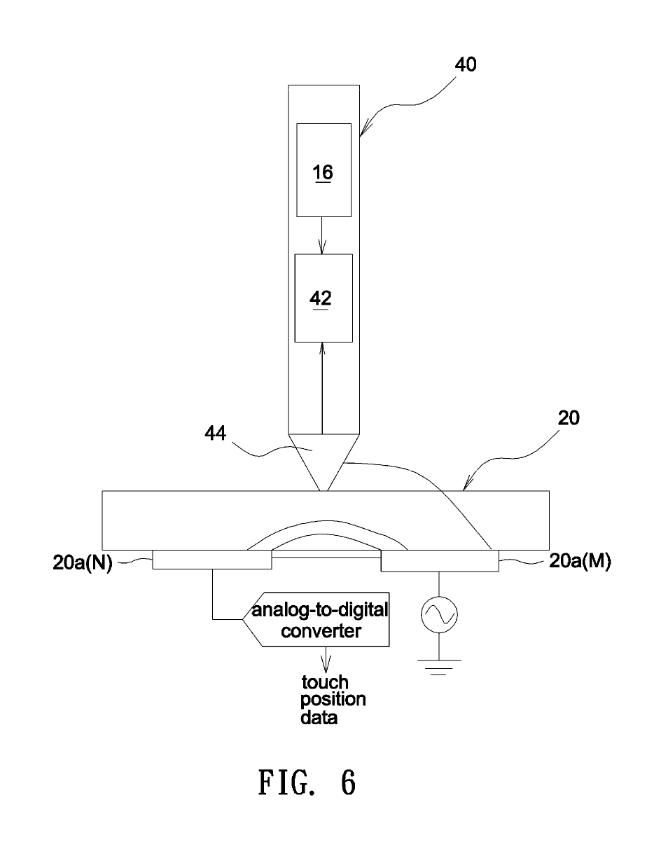

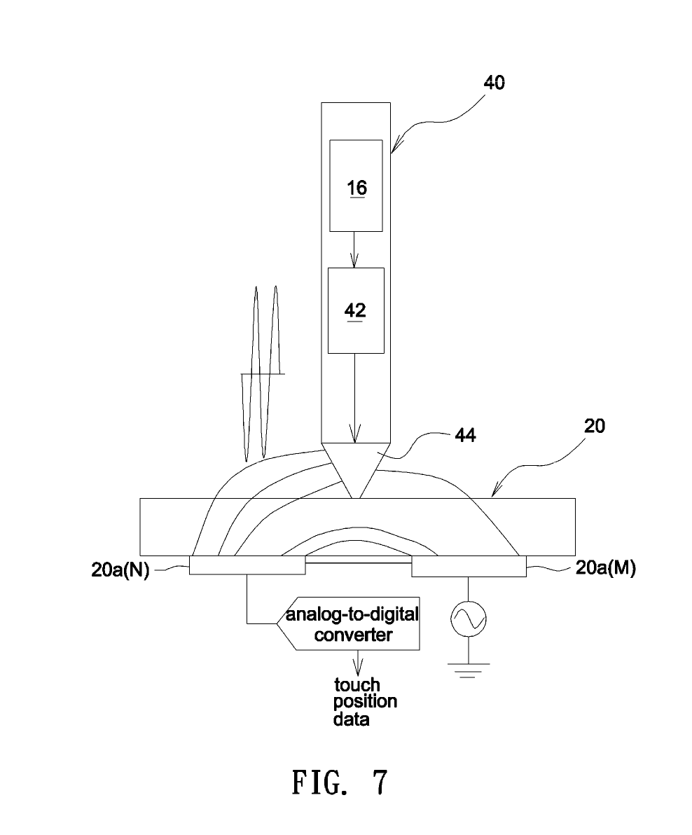

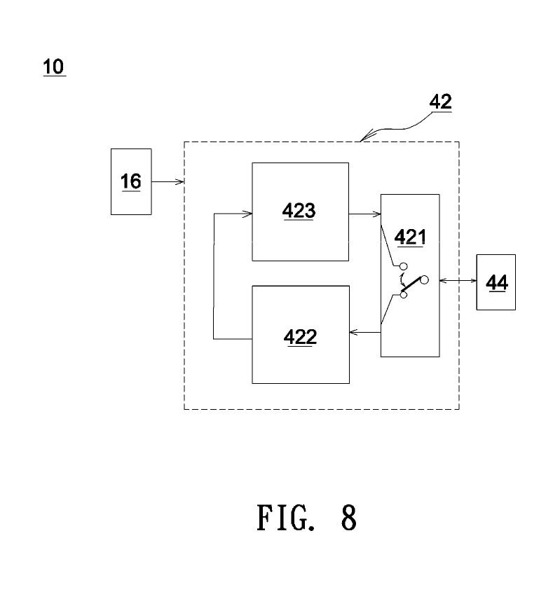

FIG. 6 and FIG. 7 show schematic diagrams of a touch pen for a capacitive touch-sensitive device according to another embodiment of the invention. FIG. 8 shows a block diagram illustrating the operation of the touch pen. Referring to both FIG. 6 and FIG. 7, in this embodiment, signal-receiving circuitry and signal-emitting circuitry of a touch pen 40 are integrated into an application specific integrated circuit (ASIC)42, and a signal-receiving operation (shown in FIG. 6) and a signal-emitting operation (shown in FIG. 7) are both performed by the same head electrode 44. As shown in FIG. 8, in one embodiment, the ASIC 42 may include a multiplexer 421, an inverted amplifying unit 422, and a memory 423. The multiplexer 421 allows the head electrode 44 to switch between a signal reception path and a signal emission path, and therefore a single head electrode 44 is allowed to both receive and emit signals. When the head electrode 44 is switched to a signal reception path, the head electrode 44 may receive at least one surface signal P of the touch-sensing structure 20a, and then the inverted amplifying unit 42 reversely amplifying the surface signal P. The patterns of the reversely amplified surface signal P is temporarily stored in the memory 423. Thereafter, when the head electrode 44 is switched to a signal emission path, the head electrode 44 emits the reversely amplified surface signal P to attenuate a detection signal of the capacitive touch-sensitive device 20 to sense touch positions of the touch pen 40.

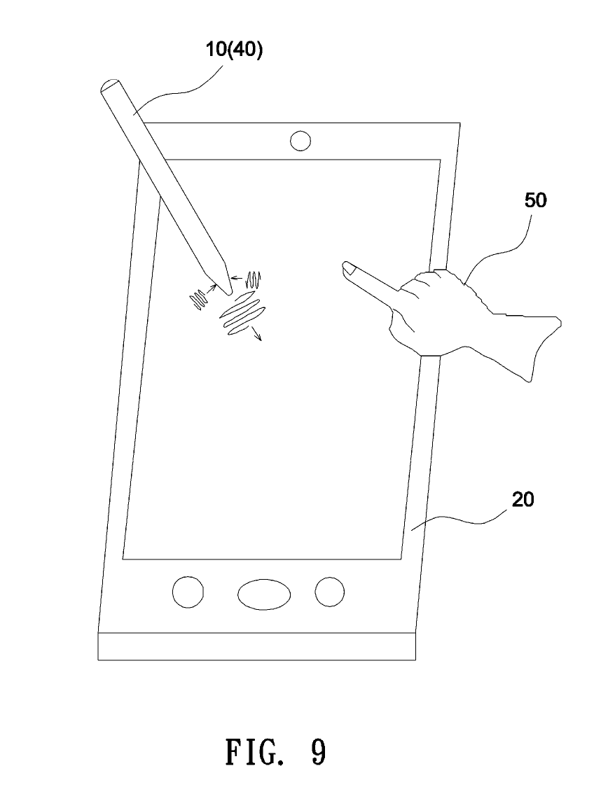

According to the above embodiment, since the signal-receiving operation and the signal-emitting operation are both performed by a single head electrode 44, the problem of interference between signal reception and signal emission is eliminated and the pen head is allowed to be further minimized. As shown in FIG. 9, the touch pen 10 or 40 according to the above embodiments or fingers 50 may input information to the capacitive touch-sensitive device 20.

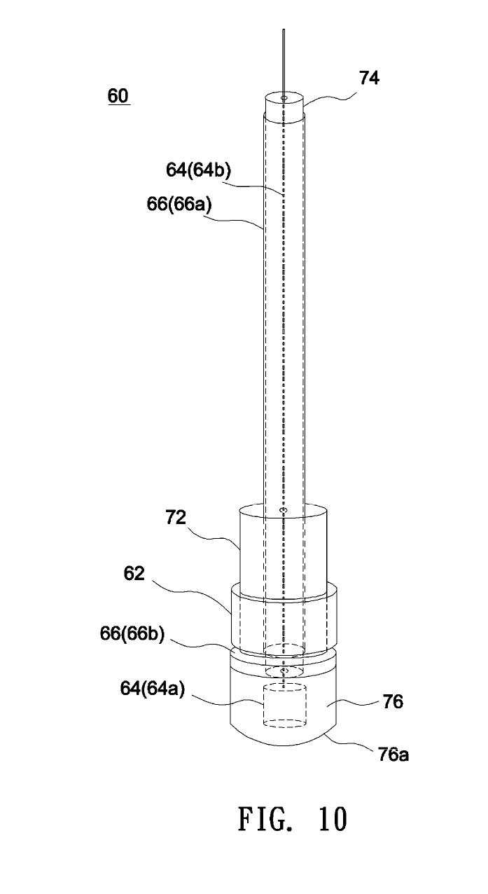

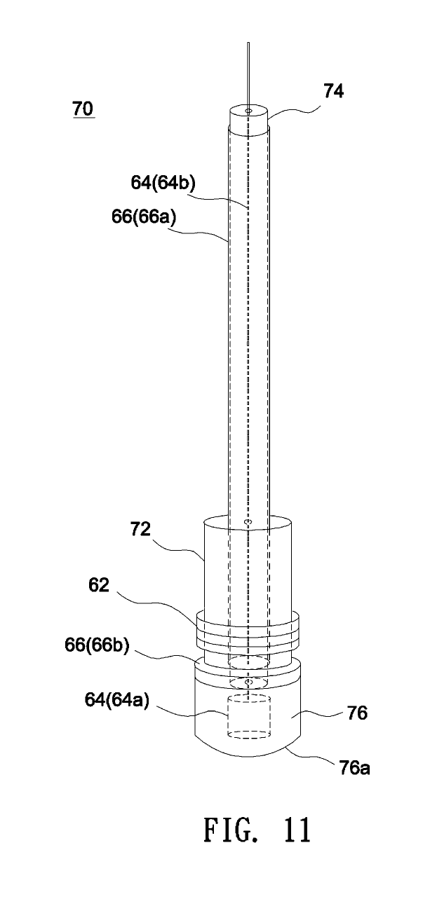

FIG. 10 shows a schematic diagram of a touch pen for a capacitive touch-sensitive device according to another embodiment of the invention. Referring to FIG. 10, a signal-receiving electrode 62 of a touch pen 60 may be made of a metal ring 64, and the signal-emitting electrode 64 may include an antenna structure 64a and an electrode wire 64b. A shielding element 66 is interposed between the signal-receiving electrode 62 and the signal-emitting electrode 64 to avoid signal interference between the signal-receiving electrode 62 and the signal-emitting electrode 64. In one embodiment, the shielding element 66 may include a hollow cylindrical part 66a and an annular part 66b connected with one end of the hollow cylindrical part 66a. The electrode wire 64b is disposed inside the hollow cylindrical part 66a, and the annular part 66b is disposed between the signal-receiving electrode 62 and the antenna structure 64a. Therefore, the electrode wire 64b of the signal-emitting electrode 64 may carry electromagnetic shielding provided by the hollow cylindrical part 66a, and the antenna structure 64a of the signal-emitting electrode 64 may carry electromagnetic shielding provided by the annular part 66b. In one embodiment, the annular part 66b may be a printed circuit board and connected to one end of the hollow cylindrical part 66a by welding. Further, in one embodiment, an outside diameter of the annular part 66b of the shielding element 66 is substantially equal to an outside diameter of the signal-receiving electrode 62. Assume an outside diameter of the hollow cylindrical part 66a is ψ1 and an outside diameter of the antenna structure 64a is ψ2, then the outside diameter of the hollow cylindrical part 66a is equal to the outside diameter of the antenna structure 64a (ψ=ψ2) or slightly larger than the outside diameter of antenna structure 64a(ψ2<ψ1<(1.2ψ2)). The shielding element 66 may be a conductor such as a copper foil, and the shielding element 66, in one embodiment, is grounded. Further, a first insulation member 72 is interposed between the signal-receiving electrode 62 and the shielding element 66, and a second insulation member 74 is interposed between the signal-emitting electrode 64 and the shielding element 66 to avoid possible short-circuiting or signal attenuation. In one embodiment, each of the first insulation member 72 and the second insulation member 74 is in the shape of a cylinder, and a length of the first insulation member 72 is larger than a length of the signal-receiving electrode 62 in an extending direction of the electrode wire 64b. In this embodiment, a conductive rubber 76 may surround the antenna structure 64a of the signal-emitting electrode 64 to prevent the touch pen 60 from scrubbing a touch panel (not shown). In one embodiment, an outside diameter of the annular part 66b of the shielding element 66 is substantially equal to an outside diameter of the conductive rubber 76. Further, the conductive rubber 76 may have at least one round corner 76a to suit a user's different body postures on using the touch pen 60. Further, according to this embodiment, since the height and surface area of the antenna structure 64a are increased, the diameter of the antenna structure 64a (pen head) is reduced to provide high fineness and comfortability on using the touch pen 60. As shown in FIG. 11, in an alternate embodiment, the signal-receiving electrode 62 of a touch pen 70 may be made of conductive coils.

Note a self-capacitance sensing method and a mutual-capacitance sensing method are both suitable for different embodiments of the invention. Further, sinusoidal waves shown in different figures merely exemplify a surface signal and an emission signal, and each of the surface signal and the emission signal may be in other form of a square wave, a pulse wave, a triangle wave, an oblique wave, etc. Besides, an amplifying power of a reversely amplified signal may be 50-500 but not limited, and the amplifying power can be selected according to the structure of a capacitive touch-sensitive device, the type of a driver IC, the structure of a touch pen, etc.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A touch pen, comprising:
a power supply circuit for providing the touch pen with a working voltage;
a signal-receiving electrode for receiving at least one surface signal of a touch-sensing structure of a capacitive touch-sensitive device;
an inverted amplifying circuit for reversely amplifying the surface signal to generate a reversely amplified signal; and
a signal-emitting electrode for emitting the reversely amplified signal to attenuate a detection signal of the capacitive touch-sensitive device in a position coinciding with a touch point of the touch pen.

2. The touch pen as claimed in claim 1, wherein an amplifying power of the inverted amplifying circuit is 50-500.

3. The touch pen as claimed in claim 1, further comprising:
a shielding element interposed between the signal-receiving electrode and the signal-emitting electrode to avoid signal interference.

4. The touch pen as claimed in claim 3, wherein the shielding element is grounded.

5. The touch pen as claimed in claim 3, wherein the shielding element is made of a copper foil.

6. The touch pen as claimed in claim 3, wherein the signal-emitting electrode comprises an antenna structure and an electrode wire, the shielding element comprises a hollow cylindrical part and an annular part connected with one end of the hollow cylindrical part, and the electrode wire is disposed inside the hollow cylindrical part.

7. The touch pen as claimed in claim 6, wherein an outside diameter of the hollow cylindrical part is equal to or slightly larger than an outside diameter of the antenna structure.

8. The touch pen as claimed in claim 6, wherein an outside diameter of the annular part of the shielding element is substantially equal to an outside diameter of the signal-receiving electrode.

9. The touch pen as claimed in claim 6, wherein the annular part is a printed circuit board and connected to one end of the hollow cylindrical part by welding.

10. The touch pen as claimed in claim 3, further comprising:
a first insulation member interposed between the signal-receiving electrode and the shielding element; and
a second insulation member interposed between the signal-emitting electrode and the shielding element.

11. The touch pen as claimed in claim 10, wherein each of the first insulation member and the second insulation member is in the shape of a cylinder.

12. The touch pen as claimed in claim 10, wherein the signal-emitting electrode comprises an antenna structure and an electrode wire, and a length of the first insulation member is larger than a length of the signal-receiving electrode in an extending direction of the electrode wire.

13. The touch pen as claimed in claim 1, wherein the signal-receiving electrode is made of a metal ring or conductive coils.

14. The touch pen as claimed in claim 1, wherein the signal-emitting electrode comprises an antenna structure and an electrode wire, and the touch pen further comprises a conductive rubber to surround the antenna structure

15. The touch pen as claimed in claim 14, further comprising a shielding element interposed between the signal-receiving electrode and the signal-emitting electrode, wherein the shielding element comprises a hollow cylindrical part and an annular part connected with one end of the hollow cylindrical part, and an outside diameter of the annular part is substantially equal to an outside diameter of the conductive rubber.

16. The touch pen as claimed in claim 14, wherein the conductive rubber has at least one round corner.

17. The touch pen as claimed in claim 1, wherein the touch-sensing structure comprises a plurality of first sensing series and a plurality of second sensing series, the first sensing series receive at least one scan signal, the second sensing series receive the detection signal, and each first sensing series driven by the scan signal emits power lines that are received by the signal-receiving electrode.

18. A touch pen, comprising:
a power supply circuit for providing the touch pen with a working voltage;
a head electrode for receiving at least one surface signal of a touch-sensing structure of a capacitive touch-sensitive device, wherein the surface signal is reversely amplified by an inverted amplifying unit to generate a reversely amplified signal, and the head electrode emits the reversely amplified signal to attenuate a detection signal of the capacitive touch-sensitive device in a position coinciding with a touch point of the touch pen; and
a multiplexer allowing the head electrode to switch between a signal reception path and a signal emission path.

19. The touch pen as claimed in claim 18, further comprising:
a memory for temporarily storing the patterns of the reversely amplified signal.

20. The touch pen as claimed in claim 18, wherein the inverted amplifying unit and the multiplexer are integrated into an application specific integrated circuit (ASIC).

21. The touch pen as claimed in claim 18, wherein an amplifying power of the inverted amplifying unit is 50-500.

22. The touch pen as claimed in claim 18, wherein the touch-sensing structure comprises a plurality of first sensing series and a plurality of second sensing series, the first sensing series receive at least one scan signal, the second sensing series receive the detection signal, and each first sensing series driven by the scan signal emits power lines that are received by the head electrode.
